(19) United States
(12) Patent Application Publication
(10) Pub. No.: US 2005/0219738 A1
(43) Pub. Date: Oct. 6, 2005

(54) Insulation sheet and disk device provided with the same

(75) Inventors: Yukio Iida, Musashimurayama-shi (JP); Jun Nishida, Fuchu-shi (JP); Akio Toda, Kitatsuru-gun (JP); Hiroshi Okamura, Hamura-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/082,034

(22) Filed: Mar. 17, 2005

(30) Foreign Application Priority Data
Mar. 31, 2004 (JP) JP 2004-107343

(51) Int. Cl. G11B 17/00

(52) U.S. Cl. 360/97.01

(57) ABSTRACT

A disk device has a motor provided on a bottom wall of a case. A PCB is located opposite an outer surface of the bottom wall of the case, and an insulation sheet is sandwiched between the outer surface of the bottom wall and the PCB. The insulation sheet has a sheet body formed of an insulator and located opposite the outer surface of the bottom wall and a plurality of damping members provided independently of one another on the sheet body. The damping members include a first damping member situated near the motor and abutting against the PCB and a second damping member abutting against an electronic component mounted on the PCB.

### CROSS-REFERENCE TO RELATED APPLICATIONS

This application is based upon and claims the benefit of priority from prior Japanese Patent Application No. 2004-107343, filed Mar. 31, 2004, the entire contents of which are incorporated herein by reference.

### BACKGROUND OF THE INVENTION

1. Field of the Invention

This invention relates to an insulation sheet used in a disk device and the disk device provided with the insulation sheet.

2. Description of the Related Art

In recent years, disk devices, such as magnetic disk devices, optical disk devices, etc., have been widely used as external recording devices of computers and image recording devices.

A magnetic disk device as an example of a disk device generally has a case in the form of an open-topped rectangular box and a top cover that closes a top opening of the case. The case contains magnetic disks for use as magnetic recording media, a spindle motor, magnetic heads, and a head actuator. The spindle motor serves as drive means that supports and rotates the disks. The magnetic heads are used to write and read information to and from the disks. The head actuator supports the magnetic heads for movement with respect to the magnetic disks. Further, the case contains a voice coil motor, a substrate unit, etc. The voice coil motor rocks and positions the head actuator. The substrate unit has a head IC and the like.

A printed circuit board (hereinafter referred as a PCB) is screwed to the outer surface of the bottom wall of the case. It controls the operations of the spindle motor, voice coil motor, and magnetic heads through the substrate unit. Various semiconductor devices, shock sensor, I/F connector, etc. are mounted on the PCB. A sheetlike damping member of an insulator is located between the bottom wall of the case and the PCB lest vibration attributable to the rotation of the spindle motor be transmitted to the PCB (e.g., U.S. Pat. No. 5,235,482). With use of this damping member, noise from the spindle motor can be reduced, and the detection accuracy of the shock sensor on the PCB can be improved.

In the conventional disk device described above, the uniform damping member is interposed between the case bottom wall and the PCB, substantially covering the whole bottom surface of the case. With this arrangement, a thick damping member must be used in order to enhance a vibration suppression effect. If the thick sheetlike damping member is interposed between the case and the PCB, however, the PCB warps and touches a case mounting portion, thereby possibly causing an electrical short circuit. If no short circuit is caused, terminal areas of the semiconductor devices may possibly peel and cause contact failure as the PCB warps.

### BRIEF SUMMARY OF THE INVENTION

According to an aspect of the invention, there is provided an insulation sheet used in a disk device, which comprises a case having a bottom wall, a disk-shaped recording medium set in the case, a motor which is provided on the bottom wall and holds and rotates the recording medium, and a printed circuit board mounted with a plurality of electronic components and opposed to an outer surface of the bottom wall, the insulation sheet comprising: a sheet body formed of an insulator and located opposite the outer surface of the bottom wall; and a plurality of damping members provided independently of one another on the sheet body, the damping members including a first damping member situated near the motor and abutting against the printed circuit board and a second damping member abutting against the electronic components on the printed circuit board.

According to another aspect of the invention, a disk device comprises: a case having a bottom wall; a disk-shaped recording medium set in the case; a motor which is provided on the bottom wall and holds and rotates the recording medium; a printed circuit board mounted with a plurality of electronic components and opposed and attached to an outer surface of the bottom wall; and an insulation sheet provided between the outer surface of the bottom wall and the printed circuit board. The insulation sheet has a sheet body formed of an insulator and located opposite the outer surface of the bottom wall and a plurality of damping members provided independently of one another on the sheet body, the damping members including a first damping member situated near the motor and abutting against the printed circuit board and a second damping member abutting against the electronic components on the printed circuit board.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exploded perspective view showing a hard disk drive (hereinafter referred as an HDD) according to an embodiment of the invention;

FIG. 2 is an exploded perspective view showing the reverse side of the HDD;

FIG. 3 is a perspective view showing the reverse side of the HDD;

FIG. 4 is a side view of the HDD;

FIG. 5A is a side view showing an insulation sheet of the HDD;

FIG. 5B is a plan view of the insulation sheet;

FIG. 6 is a plan view showing a PCB of the HDD; and

FIG. 7 is a perspective view showing an insulation sheet according to another embodiment of the invention.

### DETAILED DESCRIPTION OF THE INVENTION

An embodiment in which this invention is applied to an HDD as a disk device will now be described in detail with reference to the accompanying drawings.

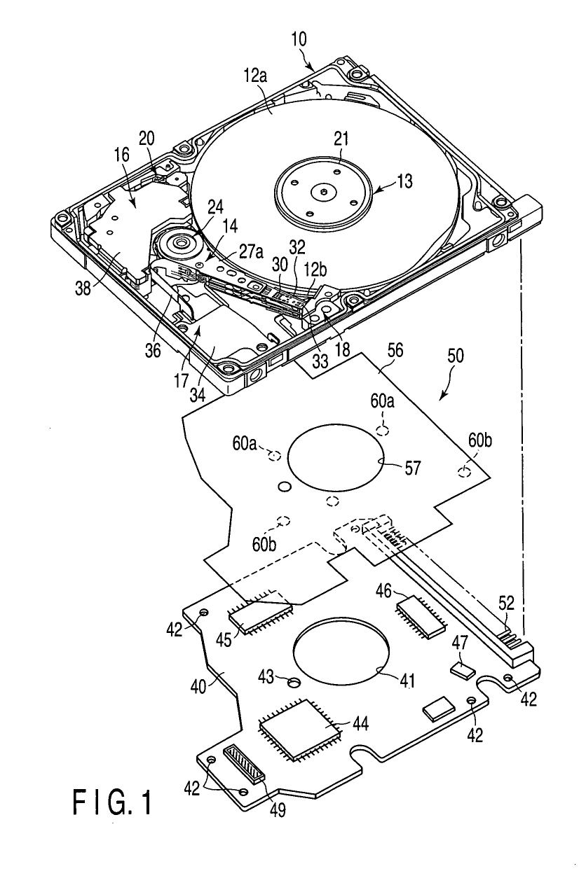

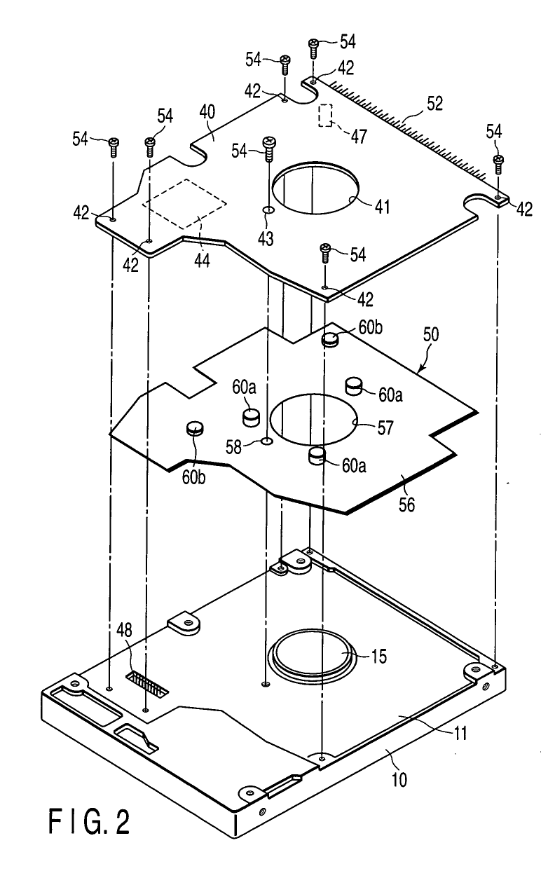

As shown in FIGS. 1 and 2, the HDD comprises a case 10 in the form of an open-topped rectangular box and a top cover (not shown), which is fixed to the case by screws and closes a top opening of the case.

The case 10 contains two magnetic disks 12a and 12b for use as recording media, spindle motor 13, magnetic heads, head actuator 14, voice coil motor (hereinafter referred as a VCM) 16, ramp load mechanism 18, inertia latch mechanism 20, and flexible printed circuit board unit (hereinafter referred as an FPC unit) 17. The magnetic heads record and reproduce information to and from the magnetic disks. The head actuator 14 supports the magnetic heads for movement relative to the magnetic disks 12a and 12b. The VCM 16 rotates and positions the head actuator. The ramp load mechanism 18 holds the magnetic heads at a distance from the magnetic disks when the heads are moved to the outermost peripheries of the disks. The inertia latch mechanism 20 holds the head actuator 14 in a retreated position. Circuit components, such as a preamp, are mounted on the FPC unit 17. The case 10 has a bottom wall 11. The spindle motor 13, head actuator 14, VCM 16, etc. are arranged on the inner surface of the bottom wall 11. A core portion 15 of the spindle motor 13 in the form of a column protrudes from a substantially central part of the outer surface of the bottom wall 11.

Each of the magnetic disks 12a and 12b is 65 mm (2.5 inches) in diameter, for example, and has magnetic recording layers on its upper and lower surfaces, individually. The two disks 12a and 12b are coaxially fitted on a hub (not shown) of the spindle motor 13 and clamped by a clamp spring 21. They are stacked in layers at a given space in the axial direction of the hub. The magnetic disks are rotated at a given speed by the motor 13 as a drive unit.

The head actuator 14 comprises a bearing assembly 24 fixed on the bottom wall of the case 10, four arms 27 attached to the bearing assembly, and four magnetic head assemblies 30 supported by the arms, individually. Each magnetic head assembly 30 is provided with an elongate suspension 32 formed of a leaf spring and a magnetic head 33 fixed to the suspension.

The VCM 16 has a voice coil (not shown) provided on the head actuator 14, a yoke 38 fixed on the bottom wall 11 and opposed to the voice coil, and a magnet (not shown) fixed to the yoke.

The FPC unit 17 has a rectangular board body 34 fixed on the bottom wall of the case 10, and electronic components, connectors, etc. are mounted on the board body. The FPC unit 17 has a belt-shaped main flexible printed circuit board 36 that electrically connects the board body 34 and the head actuator 14. Each magnetic head 33 that is supported by the actuator 14 is connected electrically to the FPC unit 17 through a relay FPC (not shown) provided on each arm 27 and the main flexible printed circuit board 36.

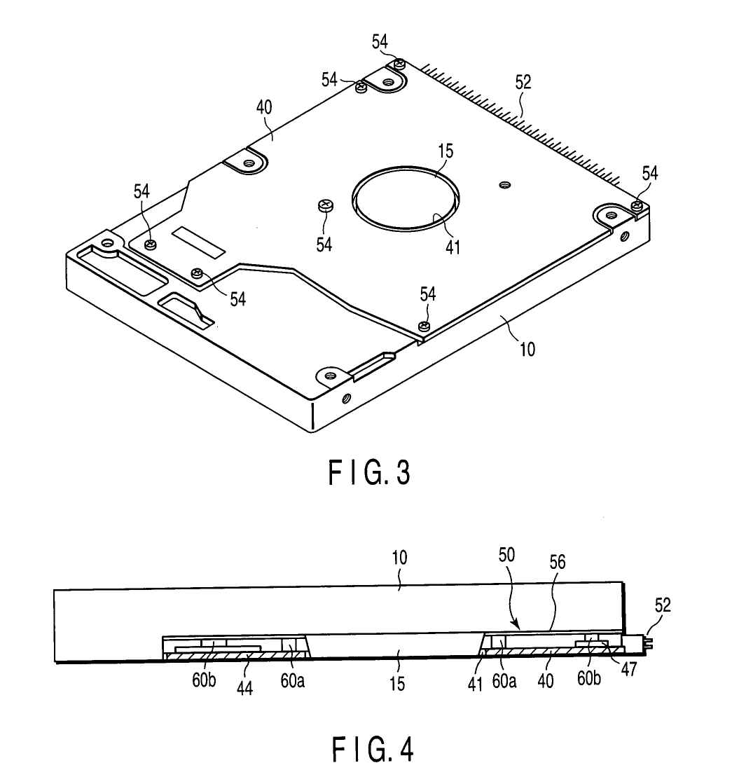

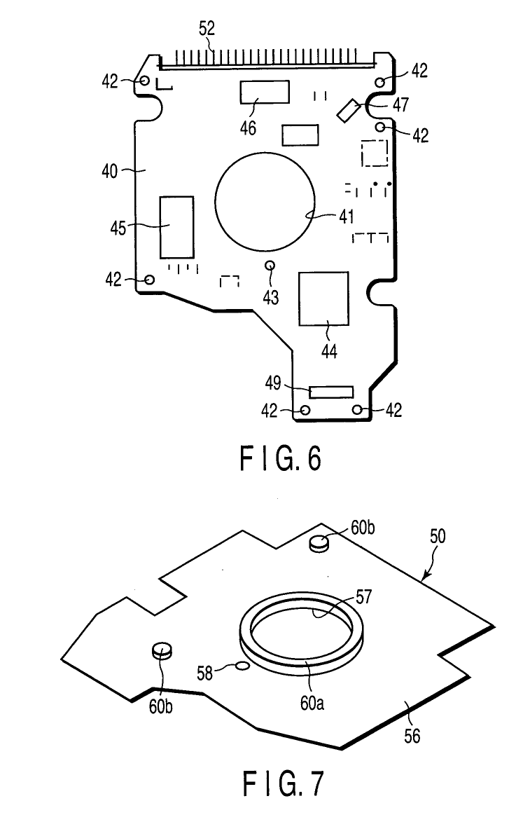

As shown in FIGS. 1 to 4 and 6, a PCB 40 that controls the operations of the spindle motor 13, VCM 16, and magnetic heads through the FPC unit 17 is screwed to the outer surface of the bottom wall 11 of the case 10 and faces the bottom wall 11. An insulation sheet 50 is interposed between the outer surface of the bottom wall 11 of the case 10 and the PCB 40.

The PCB 40 has a substantially rectangular shape corresponding to the bottom wall 11 of the case 10. A circular opening 41 through which the core portion 15 of the spindle motor 13 is passed is formed substantially in the central part of the PCB 40. Through holes 42 through which screws are passed are formed in the peripheral edge portion of the PCB 40, while another through hole 43 for the passage of a screw is formed near the opening 41 in the central part of the PCB. The through hole 43 is situated between those two of the holes 42 which are spaced farthest apart. Those parts of the PCB 40 which correspond to the holes 42 form first screwed portions in which the PCB 40 is screwed to the bottom wall 11 of the case 10, while that part which corresponds to the hole 43 forms a second screwed portion.

A large number of electronic components are mounted on the PCB 40. These electronic components include LSIs, such as an SOC 44, DRAM 45, driver 46, etc., as semiconductor devices, a shock sensor 47, and may other discrete components and chip components. The SOC 44, which has a relatively large area, is mounted on the PCB 40 and situated between the opening 41 and a PCB end edge that is at the greatest distance from the opening 41. The shock sensor 47 is mounted near one corner of the PCB 40. The PCB 40 is mounted with a second connector 49 and a main connector 52. The second connector 49 is connectable to a first connector 48 on the side of the FPC unit 17. The main connector 52 serves to connect the HDD to an electronic device, such as a personal computer.

The PCB 40 is located opposite the outer surface of the bottom wall 11 of the case 10 with its electronic component mounting surface opposed to the outer surface of the bottom wall 11 and with the second connector 49 connected to the first connector 48. The PCB 40 is fixed to the outer surface of the bottom wall 11 by screws 54 that are passed through the holes 42 and 43, individually. When the PCB 40 is attached to the outer surface of the bottom wall 11, the core portion 15 of the spindle motor 13 is situated in the opening 41 of the PCB, and the whole PCB is formed in a shape which does not overlap with a bottom wall portion in which a lower yoke of the VCM 16 is embedded.

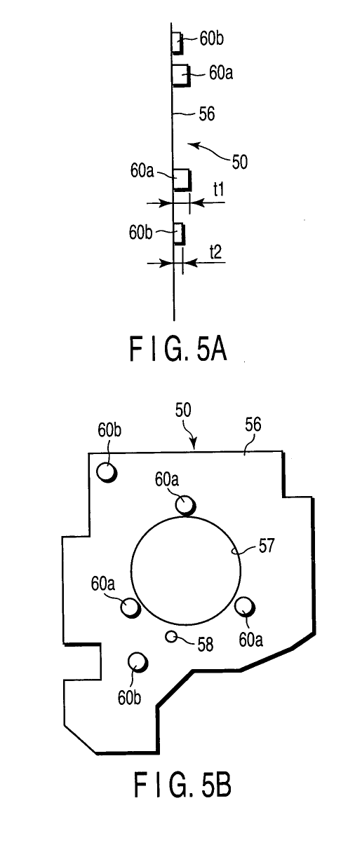

As shown in FIGS. 1 to 4 and FIGS. 5A and 5B, the insulation sheet 50 that is provided between the bottom wall 11 of the case 10 and the PCB 40 has a filmy sheet body 56 formed of an insulator, such as polyethylene terephthalate (PET), and independent damping members fixed on the sheet body. The sheet body 56 is formed having a size and shape substantially corresponding to the PCB 40. The circular opening 57 through which the core portion 15 of the spindle motor 13 is passed is formed in the central part of the sheet body 56. A through hole 58 for the passage of a screw is formed near the opening 57.

The damping members include a plurality of (e.g., three) independent first damping members 60a, which are arranged spaced around the opening 57. Each of the first damping members 60ais in the form of a column, one end of which is fixed to the surface of the sheet body 56 with an adhesive. Thus, the first damping members 60aextend substantially perpendicularly from the surface of the sheet body 56.

The damping members also include two second damping members 60b, one of which is situated at a position corresponding to the SOC 44 on the side of the PCB 40 and the other one of which to the shock sensor 47 on the PCB side. Each of the second damping members 60b is in the form of a column, one end of which is fixed to the surface of the sheet body 56 with the adhesive. Thus, the second damping members 60b extend substantially perpendicularly from the surface of the sheet body.

A thickness t2 of each second damping member 60b is smaller than a thickness t1 of each first damping member 60a. The first and second damping members 60a and 60b are formed of urethane or the like.

The second damping members 60b have a damping factor higher than that of the first damping members 60a.

The sheet body 56 of the insulation sheet 50 constructed in this manner is located and sandwiched between the outer surface of the bottom wall 11 and the PCB 40. Its obverse side on which the first and second damping members 60a and 60b are arranged is opposed to the PCB 40. The sheet body 56 is in contact with the outer surface of the bottom wall 11. The core portion 15 of the spindle motor 13 is situated in the opening 57 of the sheet body 56. The sheet body 56 electrically insulates the PCB 40 from the bottom wall 11 of the case 10.

The three first damping members 60a are situated near and around the core portion 15 and abut against the PCB 40. The second damping members 60b abut against the SOC 44 or the shock sensor 47. The screw 54 that fixes the central part of the PCB 40, that is, the second screwed portion, is screwed into the bottom wall 11 through the through hole 58 of the sheet body 56 and situated near the first damping members 60a.

According to the HDD constructed in this manner, the insulation sheet 50 has the independent damping members. Among these damping members, the three first damping members 60a are arranged opposite and around the periphery of the core portion 15 of the spindle motor 13 that constitutes a source of vibration. Thus, vibration that is caused by rotation of the motor 13 is transmitted to the first and second damping members 60a and 60b, whereupon it is efficiently damped by these damping members. In this manner, the PCB 40 can be restrained from vibrating.

The second damping members 60b are kept in contact with the SOC 44 or the shock sensor 47 that is highest on the PCB 40. Thus, the vibration from the spindle motor 13 is damped by the second damping members 60b for almost all the regions of the PCB 40 with the electronic components thereon as it is transmitted to the PCB. Thereupon, the PCB 40 can be prevented from vibrating. Further, vibration that is transmitted to the shock sensor 47 is damped by the second damping members 60b. Thus, the sensor 47 can detect with high accuracy an acceleration that acts on the whole HDD, without the possibility of detection errors that are attributable to the vibration of the spindle motor 13.

The SOC 44 is an LSI, which is externally stiffened with resin and has a relatively large area.

Therefore, that region of the PCB 40 which carries the SOC 44 thereon is higher in bending stiffness than the other region around the SOC in which no electronic components are mounted. If the second damping members 60b are arranged between the SOC 44 and the case bottom wall, therefore, the amount of warp in the PCB can be reduced.

The first damping members 60a are arranged around the core portion 15 of the spindle motor 13. The warp in the PCB 40 can be reduced by providing at least one second screwed portion, which fixes the PCB and the case bottom wall to each other, around the core portion. In any other region than the peripheral portion of the PCB 40, therefore, the warp in the PCB can be reduced by only providing a screwed portion in at least one spot around the core portion of the motor 13.

One of the thick second damping members 60b is located opposite the shock sensor 47. The sensor 47 is located on the peripheral edge portion of the PCB 40, and the first screwed portion for fixing the PCB and the case bottom wall is provided near the sensor. Thus, the warp in the PCB 40 that is caused by the second damping member 60b can be reduced considerably.

Since each damping member is stuck on the sheet body with the adhesive, there is no possibility of only some of the damping members laterally slipping during the assembly of the HDD or of some damping members being laterally dislocated by a lateral shock after completion of the HDD. Thus, a vibration suppression effect for the PCB 40 never fails to be obtained with use of a plurality of damping members.

The second damping members 60b, which abut against the SOC 44 and the shock sensor 47 that are higher than the board surface of the PCB 40, are lower in height than the first damping members 60a. Therefore, the PCB 40 can be prevented from being warped by the interposition of the second damping members. Although the second damping members 60b are lower than the first damping members 60a, moreover, they have a damping force higher than that of the first damping members 60a. Therefore, vibration transmitted from the side of the case 10 can be damped efficiently.

As described above, the thick damping members that have a high vibration suppression effect are interposed between the case bottom wall 11 and the PCB 40 to suppress vibration of the PCB, thereby lowering noise from the HDD. For the resulting HDD and insulation sheet, the impact detection accuracy of the shock sensor on the PCB is improved. The first and second damping members 60a and 60b are located only on the high-stiffness portions of the PCB 40 and around the screwed portions of the PCB. Therefore, the warp in the PCB that is caused by the second damping member can be lessened, so that the PCB can be prevented from jumping out as the HDD is set in place. Since each damping member is stuck integrally on the sheet body with the adhesive, there is no possibility of only some of the damping members laterally slipping during the assembly of the HDD or of some damping members being laterally dislocated by a lateral shock after completion of the HDD. Thus, the PCB can continually enjoy the vibration suppression effect.

The present invention is not limited directly to the embodiment described above, and its components may be embodied in modified forms without departing from the scope or spirit of the invention. Further, various inventions may be made by suitably combining a plurality of components described in connection with the foregoing embodiment. For example, some of the components according to the foregoing embodiment may be omitted. Furthermore, components according to different embodiments may be combined as required.

For example, the damping members of the insulation sheet are expected only to be arranged independently of one another and may be of any other shape than a columnar one. As shown in FIG. 7, a first damping member 60a may be formed in the shape of a ring that extends around the core portion 15 of the spindle motor 13. The number of damping members may be increased or reduced, if necessary, and their material may be variously selected as required.

Further, the second damping members 60b that abut against the electronic components on the PCB need not be equal in thickness and may be formed having different thicknesses corresponding to the respective thicknesses of the components against which they abut. Although the damping members are arranged on the surface that faces the PCB of the sheet body, furthermore, they may alternatively be provided on the other surface or both surfaces of the sheet body.

The number of magnetic disk in the HDD is not limited to one and may be increased as required. This invention is not limited to magnetic disk devices and may be also applied to any other disk devices, such as optical disk devices.

1. An insulation sheet used in a disk device, which comprises a case having a bottom wall, a disk-shaped recording medium set in the case, a motor which is provided on the bottom wall and holds and rotates the recording medium, and a printed circuit board mounted with a plurality of electronic components and opposed to an outer surface of the bottom wall, the insulation sheet comprising:
a sheet body formed of an insulator and located opposite the outer surface of the bottom wall; and
a plurality of damping members provided independently of one another on the sheet body,
the damping members including a first damping member situated near the motor and abutting against the printed circuit board and a second damping member abutting against the electronic components on the printed circuit board.

2. The insulation sheet according to claim 1, wherein the second damping member is thinner than the first damping member.

3. The insulation sheet according to claim 1, wherein the second damping member has a damping factor higher than that of the first damping member.

4. The insulation sheet according to claim 1, wherein the first and second damping members are fixed with an adhesive to that surface of the sheet body which faces the printed circuit board.

5. A disk device comprising:
a case having a bottom wall;
a disk-shaped recording medium set in the case;
a motor which is provided on the bottom wall and holds and rotates the recording medium;
a printed circuit board mounted with a plurality of electronic components and opposed and attached to an outer surface of the bottom wall; and
an insulation sheet provided between the outer surface of the bottom wall and the printed circuit board,
the insulation sheet having a sheet body formed of an insulator and located opposite the outer surface of the bottom wall and a plurality of damping members provided independently of one another on the sheet body, the damping members including a first damping member situated near the motor and abutting against the printed circuit board and a second damping member abutting against the electronic components on the printed circuit board.

6. The disk device according to claim 5, wherein the damping members include a plurality of first damping members situated spaced near the motor and individually abutting against the printed circuit board.

7. The disk device according to claim 5, wherein the first damping member is formed in a ring so as to surround the motor.

8. The disk device according to claim 5, wherein the damping members include a plurality of second damping members which are provided independently of one another on the sheet body and individually abut against the printed circuit board.

9. The disk device according to claim 8, wherein the electronic components mounted on the printed circuit board include semiconductor devices and a shock sensor, and the second damping members abut against at least one of the semiconductor devices or the shock sensor.

10. The disk device according to claim 5, wherein the first and second damping members are fixed with an adhesive to that surface of the sheet body which faces the printed circuit board.

11. The disk device according to claim 5, wherein the second damping member is thinner than the first damping member.

12. The disk device according to claim 5, wherein the second damping member has a damping factor higher than that of the first damping member.

13. The disk device according to claim 5, wherein the printed circuit board has a plurality of screwed portions individually screwed to the bottom wall of the case, the screwed portions including a plurality of first screwed portions situated individually on peripheral edge portions of the printed circuit board and a second screwed portion situated near the first damping member.
